(19) United States
(12) Patent Application Publication
(10) Pub. No.: US 2014/0310375 A1
(43) Pub. Date: Oct. 16, 2014

(54) NETWORK NODE APPARATUS FOR INFORMATION-CENTRIC NETWORKING AND OPERATING METHOD OF THE NETWORK NODE APPARATUS

(71) Applicant: ELECTRONICS AND TELECOMMUNICATIONS RESEARCH INSTITUTE, Daeheib-si (KR)

(72) Inventors: Hong-Seok JEON, Daejeon-si (KR); Byung-Joon LEE, Daejeon-si (KR); Tae-Yeon KIM, Daejeon-si (KR); Seung-Hyun YOON, Daejeon-si (KR)

(73) Assignee: ELECTRONICS AND TELECOMMUNICATIONS RESEARCH INSTITUTE, Daejeon-si (KR)

(21) Appl. No.: 14/173,060

(22) Filed: Feb. 5, 2014

(30) Foreign Application Priority Data
Feb. 5, 2013 (KR) 10-2013-0013106
Feb. 5, 2014 (KR) 10-2014-0012831

(51) Int. Cl. H04L 29/08

(52) U.S. Cl. CPC H04L 67/10
USPC 709/217

(57) ABSTRACT

A network node apparatus for Information-Centric Networking (ICN) and an operating method thereof. The network node apparatus has a control plane and a data plane, which are separate from each other, and manages location information of content on the data plane concentratedly. For example, the network node apparatus includes a Content Service Coordination Function (CSCF) configured to process a content request from a user or a publication request from a content provider; a Content Delivery Control Function (CDCF) configured to select an optimal service node to handle the content request or the publication request; and a Content Delivery Service Function (CDSF) configured to download requested content to the user or to download from the content provider content requested to be published and then register the downloaded content.

### CROSS-REFERENCE TO RELATED APPLICATION(S)

This application claims the benefit under 35 U.S.C. §119(a) of Korean Patent Application Nos. 10-2013-0013106, filed on Feb. 5, 2013, and 10-2014-0012831, filed on Feb. 5, 2014, in the Korean Intellectual Property Office, the entire disclosures of which are incorporated herein by references for all purposes.

### BACKGROUND

1. Field

The following description relates to a network node apparatus for realizing Information-Centric Networking (ICN) and an operating method thereof.

2. Description of the Related Art

Information-Centric Networking (ICN) is a communication technique using identifier (ID) of desired information, rather than a host address thereof. When using ICN, a user provides a network with ID of desired information to, instead of accessing a host storing the information and then obtaining the information therefrom, and then, the network discovers the information using the ID thereof and returns the found information to the user.

Various ICN architectures have been proposed, including Data-Oriented Network Architecture (DONA), Content-Centric Networking (CCN), Publish-Subscribe Internet Technology (PURSUIT), and so on. Among them, DONA and CCN are typical ICN architectures.

DONA, developed by a team lead by Teemu Koponen at Burkeley University, U.S., defines ICN using a public key-based information ID. DONA proposes a communication model based on a hierarchical network architecture of Resolution Handlers (RHs). In response to an information request packet, an RH manages routing information to transmit an appropriate neighboring RH. In DONA, an information holder creates a register packet and transmits the register packet to an adjacent RH in order to register information that the information holder holds. The RH manages routing information based on the register packet. An information requester creates a FIND packet including ID of the information and transmits the same to an adjacent RH. The RH transmits the FIND packet to an adjacent RH based on the routing information so that the FIND packet may be transmitted to the information holder or to a specific network node that caches the information.

CCN, which is now being developed by a team lead by Van Jacobson at a Palo Alto Research Center (PARC), is an ICN architecture that utilizes hierarchically-structured is information ID. While having a similarity to Uniform Resource Location (URL) in terms of a hierarchical structured, information ID is still different from the URL since the information ID does not include address information. CCN follows a request-to-response communication model. An information requester creates an INTEREST packet, which is a request message, to a CCN network. In response to the INTEREST packet, the CCN network transmits the INTEREST packet to an information holder. The information holder creates a DATA packet in response to the INTEREST packet, and transmits the DATA packet to the CCN network as a response, and the DATA packet is transmitted to the information requester over the CCN network. In CCN, routing nodes on the CCN network have location information of all contents. Therefore, if an amount of contents increases, an amount of information that each routing nodes needs to have also grows, thereby leading to a scalability problem.

DONA solves the scalability problem by storing location information of contents in a distributive manner using a Distributed Hash Table (DHT). However, a DHT technology ignores location information of a node participating in a network. For instance, suppose that nodes located in Seoul is connected to nodes located in Busan, that a user in Seoul downloads a file A using a corresponding DHT, and that the file A is stored in a node located in Seoul. Without knowing a location of the file A, the user needs to send a query about the location of the is file A to the DHT. However, due to characteristics of the DHT, the location information of the file A may be stored in a node located in Busan, rather than a node located in Seoul. Accordingly, in order to use the file A, the user has to send a query about a location of the file A, to receive a result of the query, and then to request the file A from a node located in Seoul. As a result, a query packet may go through a considerably long transmission path for use of content, so that long-distance traffic be unnecessarily caused.

In addition, both DOAN and CCN are designed without taking into account an interface between an operator and a user. Moreover, DONA operates only in a hierarchical network architecture, so there is a limitation in applying DONA in various types of networks.

### SUMMARY

One objective of the present invention is providing a network node apparatus, which not only realizes Information-Centric-Networking (ICN) that is naturally in association with various networks including an Internet Protocol (IP) network, but also easily supports primary ICN functions, such as on-path caching, and an operating method of the network node apparatus. Still another objective of the present invention is providing a network node apparatus for ICN, which not only is able to efficiently solve a scalability problem of routing nodes, but also makes a traffic flow efficient, and an operating method of the network node apparatus.

Yet another objective of the present invention is providing a network node apparatus for ICN, which provides an interface that is convenient for a user and easily interworks with an existing operator, and an operating method of the network node apparatus.

The following description relates to a network node apparatus for Information-Centric Networking (ICN), wherein the network node apparatus has a control plane and a data plane, which are separate from each other, and manage location information of content on the data plane concentratedly.

In one general aspect, there is provided a network node apparatus for Information-Centric Networking (ICN), including: a Content Service Coordination Function (CSCF) configured to, in response to a content request for first content from a user, transmit a query about a first content service node to handle the content request, to receive a response to the query, and to enable the content request to be redirected to the first content service node; a Content Delivery Control Function (CDCF) configured to, in response to the query from the CSCF which receives the content request, select the first content service node from among one or more content service nodes storing the first content, and to notify the CSCF of the selected first content service node; and a Content Delivery Service Function (CDSF) configured to, in response to the redirected content request, transmit the first content to the user.

The CSCF may be further configured to identify content identifier (ID) of the first content based on address information thereof included in the received content request, and to transmit the query including the content ID of the first content to the CDCF.

The CSCF may be further configured to derive an Internet Protocol (IP) address of the user and content address information and the content ID of the first content from the received content request, to include the IP address of the user and the content address information and content ID of the first content in a query to be transmitted to the CDCF, and the CDCF may be further configured to select the first content service node as an optimal content service node to handle the content request based on network resource information that includes proximity, is network topology and availability.

The CDCF may be further configured to manage a predetermined database that stores content IDs of contents registered in the network and one or more pieces of content location information corresponding to the respective content IDs, and the CDSF may be further configured to, in response to the redirected content request, transmit the first content to the user is using content location information of the first content, the content location information which is identified through communication with the CDCF. In the case where the first content is not stored in a storage or a cache of the first content service node, the CDSF may be further configured to perform content routing based on the content ID of the first content to receive the first content and to transmit the received first content to the user.

The CSCF may be further configured to comprise a Content Service Functional Entity (CSFE) configured to handle the content request and to enable the content request to be redirected, the CDCF may be further configured to comprise a Service Optimization Functional Entity (SO_FE) configured to select the first content service node from among the one or more content service nodes, and a Content name Resolution Functional Entity (CR_FE) configured to manage a predetermined database that stores content IDs of contents registered in the network and one or more pieces of content location information corresponding to the respective content IDs, and the CDSF is further configured to comprise a Customer Service Functional Entity (CS_FE) configured to transmit the first content to the user, and a Content Transfer Functional Entity (CT_FE) configured to fetch the first content from a storage by identifying location information of the first content in association with the CR_FE, and to perform routing on the first content along a content routing path.

The CSCF may be further configured to, in response to a publication request for second content from a content provider, store publication information of the second content, and to send a query about a first publication service node to handle the received publication request to the CDCF so that the publication request for the second content is transmitted to the first publication service node, and the CDECF is further configured to, in response to the query from the CSCF is receiving the publication request, select the first publication service node from one or more publication service nodes, and to notify the selected first publication service node of the CSCF. In this case, the CDSF may be further configured to, in response to the publication request for the second content from the CSCF, download the second content from the content provider, and to store the downloaded second content along with the publication information thereof. Alternatively, the CSCF may be further configured to comprise a Content Publication Functional Entity (CP_FE) configured to handle the publication request and generate content ID of the first content, the CDECF may be further configured to comprise a Service Optimization Functional Entity (SO_FE) configured to select the first publication service node from among the one or more publication service nodes, and a Content name Resolution Functional Entity (CR_FE) configured to manage a predetermined database that stores content IDs of contents registered in the network and one or more pieces of content location information corresponding to the respective content IDs, and the CDSF may be further configured to comprise a Customer Service Functional Entity (CSFE) configured to download the second content from the content provider and to store the downloaded second content along with publication information thereof.

In still another general aspect, there is provided a network node apparatus for Information-Centric Networking (ICN) in a network in which a plurality of service node, each service node which has a cache, and at least some of the plurality of service nodes have respective local storages. The network node apparatus includes a Content Service Coordination Function (CSCF) configured to, in response to a content request for first content from a user, enable the content request to be redirected to the first content service node; a Content Delivery Control Function (CDCF) configured to, in response to the query from the CSCF which receives is the content request, select the first content service node for processing the content request from among one or more content service nodes storing the first content, and to notify the CSCF of the selected first content service node; and a Content Delivery Service Function (CDSF) configured to, in response to the redirected content request, transmit the first content to the user.

In still another general aspect, there is provided a content service method of an apparatus for Information-Centric Networking (ICN), the content service method comprises operations including: (a) receiving, at a Content Service Coordination Function (CSCF), a content request for a first content from a user; (b) sending, at the CSCF, to a Content Delivery Control Function (CDCF) a query about information on a first content service node for processing the content request; (c) selecting, the CDCF, selecting the first content servicer node from one or more content service nodes storing the first content and notifying the CSCF of the selected first content service node; (d) enabling, at the CSCF, the content request to be redirected to the first content service node; and transmitting the first content from a Content Delivery Service Function (CDSF) which has received the redirected content request to the user. The operation (b) may further include identifying content identifier (ID) of the first content based on content address information thereof included in the received content request, including the identified content ID of the first content in the query, and transmitting the query to the CDCF. In this case, the to operation (d) further include operations including: (d1) requesting, at the CSCF, that the content request for the first content be redirected to the first content service node; and (d2) receiving, at the CDSF, from the user the content request using the ID of the first content. In addition, the operation ε may further include operations including: (e1) requesting, at the CDSF which has received the content request, the first content from the CDCF using the content ID of the first is content; and transmitting the first content from the CEDCF to the CDSF by fetching the first content from a storage or a cache or performing routing the first content along a content routing path.

In yet another general aspect, there is provided a content publication method of a network node apparatus for Information-Centric Networking (ICN), the content publication method comprises operations including: (a) receiving, at a Content Service Coordination Function (CSCF), a publication request for first content from a content provider; (b) generating, at the CSCF, content identifier (ID) of the first content; (c) transmitting from the CSCF to a Content Delivery Control Function (CDCF) a query about information on a first publication service node to handle the publication request; (d) selecting, at the CDCF, a first publication service node for processing the publication request from among one or more publication service nodes and notifying the CSCF of the selected first publication service node; (e) transmitting the CSCF, to a Content Delivery Service Function (CDSF) a publication request for the first content; and (f) downloading, at the CDSF, the first content from the content provider.

In the operation (c), the CSCF may transmit to the CDCF a content registration request message that includes the content ID of the first content and address information of the content provider, and, in the operation (d), the CSCF may receive from the CDCF a content registration is response message that includes address information of the first publication service node. In this case, the operation (d) may further include operations including (d1) transmitting from a Content name Resolution Functional Entity (CR_RE) of the CDCF which has received the content registration request message to a Service Optimization Functional Entity (SO_FE) of the CDCF a publication service node request, (d2) selecting, at the SO_E, the first publication service is node from among the one or more publication service nodes; and (d3) transmitting from the SO_FE to the CR-FE a publication service node selection response that includes address information of the first publication service node.

The content publication method may further include operations including (g) registering, at a Customer Service Functional Entity (CS_FE) of the CDSF, the downloaded first content in a Content Transfer Functional Entity (CT_FE); and (h), in response to the content publication request transmitted in the operation (e), transmitting a content publication response from the CDSF that registers the first content.

In still another general aspect, there is provided a content service method using Content Service Coordination Function (CSCF) of a network node apparatus for Information-Centric Networking (ICN), the content service method comprises operations including: (a) receiving a content request for a first content from a user; (b) sending to a Content Delivery Control Function (CDCF) a query about information on a first content service node for processing the content request; (c) receiving information on the first content service node that is selected by the CDCF from among one or more service nodes storing the first content; and (d) enabling the content request to be redirected to the first content service node so that a Content Delivery Service Function (CDSF) transmits the first content to the user.

The operation (b) may further include identifying content identifier (ID) of the first content based on content address information thereof included in the received content request, including the identified content ID of the first content in the query, and transmitting the query to the CDCF. In this case, the operation (d) further include transmitting a redirecting request to redirect the content request for the first content to the first content service node, and, in response to the redirecting request, transmitting the content request for the first content from the user to the CDSF using the content ID of the first content. In addition, after the operation (d), the CDSF may be further configured to, in response to the content request, transmit to the CDCF the content request for the first content using the content ID of the first content, and the CDCF may be further configured to transmit the first content to the CDSF by fetching the first content from a storage or a cache or performing routing the first content along a content routing path.

In yet another general aspect, there is provided a content publication method using a Content Service Coordination Function (CSCF) of a network node apparatus for Information-Centric Networking (ICN), the content publication method comprises operations including: (a) receiving a publication request for first content from a content provider; (b) generating content identifier (ID) of the first content; (c) transmitting to a Content Delivery Control Function (CDCF) a query about information on a first publication service node to handle the publication request; (d) receiving information on the first publication service node that is selected by the CDCF from among one or more publication service nodes; and (e) transmitting the publication request for the first content to the CDCF so that the CDSF downloads the first content from the content provider.

The operation (c) may further include transmitting to the CDCF a content registration request message that includes the content ID of the first content and address information of the content provider, and the operation (d) may further include receiving from the CDCF a content registration response message that includes address information of the first publication service node. In this case, the operation (d) may further include transmitting from a Content name Resolution Functional Entity (CR_RE) of the CDCF to a Service Optimization Functional Entity (SO_FE) of the CDCF a publication service node request, and transmitting from the SO_FE to the CR-FE a publication service node selection response that includes address information of the first publication service node selected from among the one or more publication service nodes.

The operation (f) may further include, in response to the content publication request, receiving a content publication response from the CDSF that registers the first content.

Other features and aspects may be apparent from the following detailed description, the drawings, and the claims.

### BRIEF DESCRIPTION OF THE DRAWINGS

FIG. 1 is a block diagram illustrating a configuration a network node apparatus for Information-Centric Networking (ICN) according to an exemplary embodiment of the present invention;

FIG. 2 is a diagram illustrating a relationship between a control node and service nodes to explaining functions of the network node apparatus shown in FIG. 1.

FIG. 3 is a diagram illustrating an example of a relationship between functions during a content publication process using the network node apparatus shown in FIG. 1.

FIG. 4 is a diagram illustrating an example of a message flow chart between functions during a content publication process using the network node apparatus shown in FIG. 1.

FIG. 5 is a diagram illustrating an example of a relationship between functions during a content service procedure using the network node apparatus shown in FIG. 1.

FIG. 6 is a diagram illustrating an example of a message flow chart between functions is during a content service process using the network node apparatus shown in FIG. 1.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

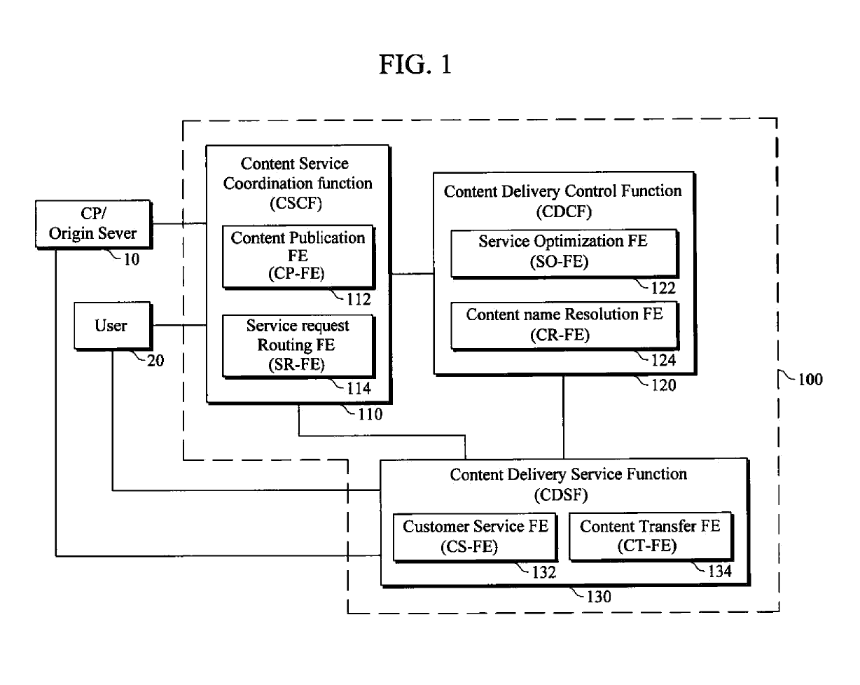

FIG. 1 is a block diagram illustrating a configuration of a network node apparatus for Information-Centric Networking (ICN) according to an exemplary embodiment. Referring to FIG. 1, a networking node apparatus 100 performs a Content Service Coordination Function (CSCF) 110, a Content Delivery Control Function (CDCF) 120, and Content Delivery Service Function (CDSF) 130. It is an example in which functions the network node apparatus 100 are logically distinguished, but aspects of the present disclosure are not limited thereto.

The network node apparatus 100 may be an apparatus for a distributed service node that performs routing of content and provides content to a user based on name and identifier (ID) of the content on Smart Ubiquitous Network (SUN) which is defined by International Telecommunication Union Telecommunication standardization sector (ITU-T). Every service node on the SUN may have all the configuration elements that are included in the network node apparatus 100, but aspects of the present disclosure are not limited thereto. According to an embodiment, a specific service node may have all the configuration elements, but other service nodes may have simply some of the configuration elements. Even in the latter case, at least one of the above described configuration elements is provided in view of the whole network. For example, at least one of the above described functions 110, 120 and 130 may be provided by two or more network node apparatuses 100. In addition, the configuration elements of the network node apparatus 100 shown in FIG. 1 may be combined into one body, or may be separated into two or more.

The network node apparatus 100 registers content (or information) in a network in accordance with a predetermined procedure: for example, in response to a content publication request from a content provider 10, the network node apparatus 100 assigns unique content identifier (ID) to content requested to be published. In addition, a user 20 may transmit a content request, such as a content delivery request, using a means (e.g. name and ID) for identifying the content, for example, name of the content, and, the network node apparatus 100 discovers the requested content from among registered content in response to the content request, and provides the discovered content to the user.

To this end, the network node apparatus 100 may have a content publication capability, a content caching capability, a content service provisioning capability, and a content routing capability.

The content publication capability refers to a capability of handling a publication request from a content provider who wishes to register content in an ICN network. The publication request from the content provider may include detailed content information including location information of a content source or origin. The content source or origin indicates an object (e.g. a server) in which the content provider stores and manages corresponding content. Based on the content information, the network node apparatus 100 downloads the corresponding content from the content source and stores the downloaded content in a storage of the network. The content caching capability refers to a capability of distributing content in content caches of a service node. Accordingly, it is possible to optimize content traffic by reducing a distance between a content source and an end user. For example, content may be dynamically distributed to a plurality of caches (that is, a plurality of service nodes) along a content routing path. The content service provisioning capability refers to a capability of handling a content request or a content delivery request from an end user. The network node apparatus 100 selects a suitable content using content IDs of contents, which are determined according to context of a user, and discovers an optimal content location (e.g. a location of a service node where requested content is stored or cached) which may efficiently transmit content requested by the end user. At this point, the network node apparatus 100 may discover a location (a storage or a cache) at which the content is stored, in light of location and/or traffic optimization. The content routing capability refers to a capability of identifying a location of content based on name of the content, to such as content ID thereof. It is possible to fetch content using the content routing capability and to transmit the content to a service node that requests the content.

Hereinafter, there is provided detailed description about functional configuration elements of the network node apparatus 100 shown in FIG. 1, which are designed to provide the above-described capabilities using interactions therebetween.

The CSCF 100 coordinates a content service, including content publication, between a content provider 10 and an end user 20. To this end, the CSCF 110 handles a content publication request from the content provider 10 or a content request (e.g. content download) from the end user. To this end, the CSCF 110 may include a Content Publication Functional Entity (CP-FE) 112 and Service request Routing Functional Entity (SR-FE) 114.

The CSCF 110 acts as a gateway for an object that uses an ICN network. That is, the CSCF 110 acts as a gateway for the content provider 10 or the user 20 to access an ICN network. More specifically, the CSCF 110 acts as a content publication gateway which receives a content publication request from the content provider 10, who is the first customer, and receives, from an origin server, content requested to be published. Then, in response to a content service (e.g. download) request from the user 20 who wishes to use the content, the CSCF 100 discovers a node which is to perform the request from the user, and performs routing of the request to the discovered node.

First of all, the CSCFR 110 registers and restores content information in response to a content publication request from the content provider 10. The CSCF 110 starts to download content from a content source and registers the downloaded content along with publication information thereof. To this end, the CSCF 110 includes the CP-FE 112.

The CP-FE 112 handles a publication request from the content provider 10, and, for this purpose, a publication interface may be provided for the content provider 10. Information collected through the publication interface includes meta information, such as original name and type of the content, and such meta information may include a network address of an origin server in which the content provider actually stores the content. In addition, the CP-FE 112 generates unique content ID to identify content that is requested by a content provider to be published on a network based on meta information of the content.

In addition, the CP-FE 112 sends a query to the CDCF 120, and then identifies information on a service note, which stores content that needs to be downloaded on the ICN network, based on the network address of the origin server, which is received from the content provider 10. The CP-FE 112 transmits to the found service node a method for accessing the content in the origin server, name of the content, and information on the generated content ID of the content. The CDSF 130, specifically, the CS-FE 132 of the service node obtains the content from the origin server, and accordingly, a content publication process completes.

In the case where the user 20 requests content, the CSCF 110 enables a corresponding content request to be redirected to an optimal service node. The optimal service node may be determined by the CDCF 120. To this end, the CSCF includes the SR-FE 114.

In response to the request from the content user 20, the SR-FE 114 helps the user 20 to obtain or use corresponding content. In general, the content user 20 inputs a content request through a content user interface, such as Portal or App, and, at this point, the SR-FE 114 first processes the content request from the content user 20. In response to the content request from the content user 20, the SR-FE 114 discovers content ID of content requested by the user. Then, the SR-FE 114 selects a service node to handle the content request from the user 20. For example, in the same way as in the case of handling a content publication request, the SR-FE 114 may send a query to the CDCF 120 based on network address information of the content user 20 to thereby select a service node for handling the content request. Lastly, the SR-FE 114 helps to transmit the found content identifier and the content request from the user 20 to the selected is service node.

The CDCF 120 is a function of a network control plane, and aims to monitor network service resources and to manage name and location information of content. More specifically, the CDCF 120 identifies location information of content according to a given content ID of the content while managing network resources, that is, information of service nodes, which are stored in a local storage or in a cache. Based on the location information of the content, the CDCF 120 determines an optimal service node to carry out content publication or content service provision. To this end, the CDCF 120 may include, for example, a Service Optimization Functional Entity (SO-FE) 122 and a Content name Resolution Functional Entity (CR-FE) 124.

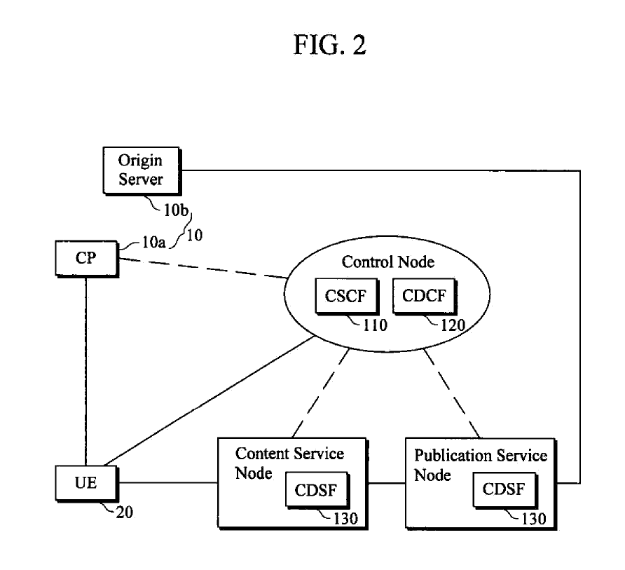

The SO-FE 122 collects state and usage information of a resource necessary for content service provision, and performs service-optimized management based on the collected information. Such a resource information collecting function of the SO-FE 122 includes a function of collecting network state information from a network, including service nodes and links thereof, and state information of the service nodes. The optimization selecting function of the SO-FE 122 is to discover, based on a network address, an optimal service node to carry out content publication or content service provision. To this end, in association with the CR-FE 124, the SO-FE 122 may derive location information of an optimal service node from among a plurality of service nodes storing corresponding content, in consideration of proximity to the corresponding content (the service node is defined with reference to FIG. 2). In addition to the network address information, integrated resource information, including network topology, proximity, network load, states of service nodes and so on, may be taken into consideration when selecting the optimal service node.

To put it simply, the SO-FE 122 determines an optimal service node which is to publish content, and determines an optimal service node to handle a content request from a content user. To this end, the SO-FE 122 may evaluate service nodes in terms of proximity, network topology and availability, and may store and monitor dynamic information of a corresponding service node, such as information on status, activity and performance.

The CR-FE manages content location information that is required for delivering content. When the content is published, the CR-FE 124 acquires a content identifier and location information of content in association with the CSCF 110, and maintains and manages correlation information between the content identifier and the location information. When receiving a query about a location of content from the CDSF 130, the CR-FE 124 identifies location information of the content based on content ID of the content, which is included in the query, and returns the identified location information. At this point, the CR-FE 124 may work in association with the SO-FE 122 in order to discover an optimal location from among a plurality of pieces of content location information.

To put it simply, the CR-FE 124 performs management of content, such as registering, deregistering and updating of content, by using content ID in association with content location information. In addition, the CR-FE 124 identifies location information of corresponding content based on the content ID thereof.

The CDSF 130, which is a function of a data plane of a network, provides an interface to transmit content data to the user 20 or receive content data from the content provider/origin server 10, and performs content request and response operations. More specifically, the CDSF 130 enables content to be delivered from the content provider 10 to the user 20. The content delivery may include several interim content delivery stages: for example, a stage where content is downloaded from a content source to a content storage of a service node, a stage where, when content is delivered from the content storage to intermediate service nodes existing on a content routing path, each of the intermediate service nodes caches the delivered content in content cache thereof, and/or a stage where the content is delivered from the content storage or the cache to the end user 20. To this end, the CDSF 130 may include a Customer Service Functional Entity (CS-FE) 132 and a Content Transfer Functional Entity (CT-FE) 134.

The CS-FE 132 relates to the above-described CSCF 110. In response to a content publication request, the CS-FE 132 downloads content from an origin server, that is, a server in which the content provider 10 stores the content. To this end, address information of the origin server, original name of the content, and content identifier information, all of which are included in the content publication request, may be used. The CS_FE 132 manages the downloaded content using content ID thereof.

To put it simply, the CS-FE 132 downloads, from a content provider or a content source, content that is requested to be published. The CS-FE 132 stores the downloaded content along with publication information thereof. In addition, the CS-FE 132 delivers content stored in a content storage or a cache to the end user 20.

In response to a content request from the CS-FE 132, the CT-FE 134 derives content ID from the content request, and determines whether corresponding content exists in a content storage and a cache thereof by using the content ID. If it is determined that the corresponding content exists, the CT-FE 134 returns the corresponding content, and, if not, sends a query about the content ID to the CR-FE 124 to obtain location information of the corresponding content. The location information of the corresponding content indicates location information of a service node that stores the corresponding content. In this case, if cached location information of the corresponding content is used, an operation of sending the query to the CR-FE 124 may be omitted.

When receiving, from the CR-FE 124, the location information of the content and information of a service node that delivers the content, the CT-FE 134 may identify the next node that will deliver the content, based on the received information. Accordingly, the CT-FE 134 may send a request for the corresponding content to the next service node, and, at the same time, the CT-FE 134 may include informations included in the received content in a predetermined database, such as a pending table, and may manage the predetermined database. The next service node delivers the content request in the same way, and, if the corresponding content is not found, returns the requested content.

To put it simply, the CT-FE 134 interacts with the CR-FE 124 to identify a content location, that is, a storage or a cache. Then, the CT-FE 134 fetches requested content from a local content storage or a cache. In addition, the CT-FE 134 relays and/or cache the requested content along a content routing path, so that the requested content may be delivered to a user.

FIG. 2 is an example of a network node apparatus shown in FIG. 1, that is, a diagram illustrating a relationship between control nodes and service nodes to explain the functions 110, 120 and 130 of the network node apparatus 100. Referring to FIG. 2, the functions 110, 120 and 130 of the network node apparatus 100 may be divided into a control node and service nodes. The service nodes include the CSCF 110 and the CDCF 120, and the service nodes includes the CDSF 130. Hereinafter, description about each network node is provided.

A service node refers to an object that corresponds to a data plane. As a physical object, the service node may include a storage to store content and a server to provide an application service. The service node may include a publication service node and a content service node. The publication service node indicates a service node that downloads a published content from an origin server 10b. The content service node indicates a service node that provides content directly to the user who requests the content. The CDSF 130 shown in FIG. 1 may be performed by a service node, that is, a publication node or a content service node.

The control node refers to an object that corresponds to a control plane. The control node provides services, such as publishing and registering content and managing location information of the content. The control node includes the CSCF 110 and the CDCF 120, which may be performed together in the sane control node or may be performed separately in different control nodes. FIG. 2 demonstrates an example in which the CSCF 110 and the CDCF 120 are performed together in the same control node.

Hereinafter, an operating method of the network node apparatus 100 shown in FIG. 1 for ICN is described. The following operating method of the network node apparatus 100 relates to a content publication process for registering content in an Information-Centric network, such as a Smart Ubiquitous Network (SUN), and a content service provisioning process for providing content requested from a user.

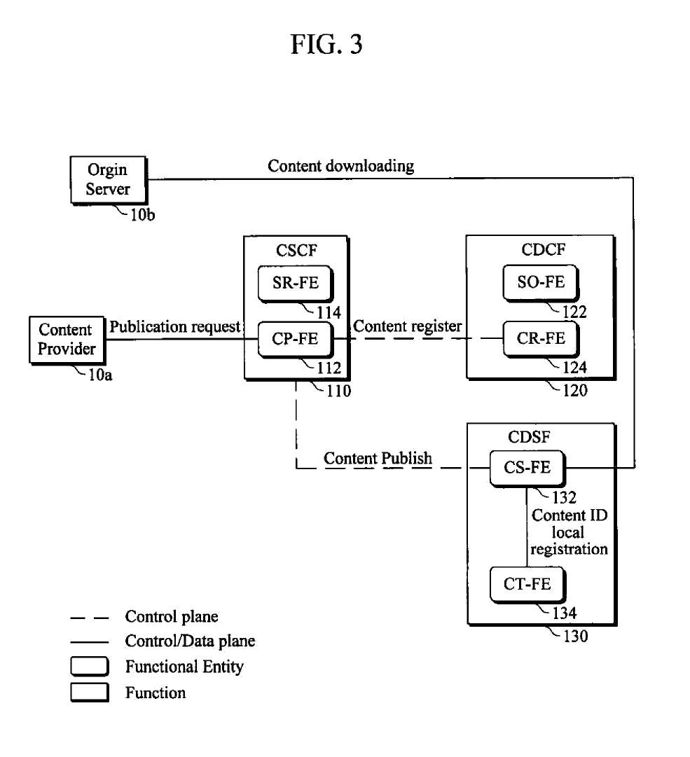

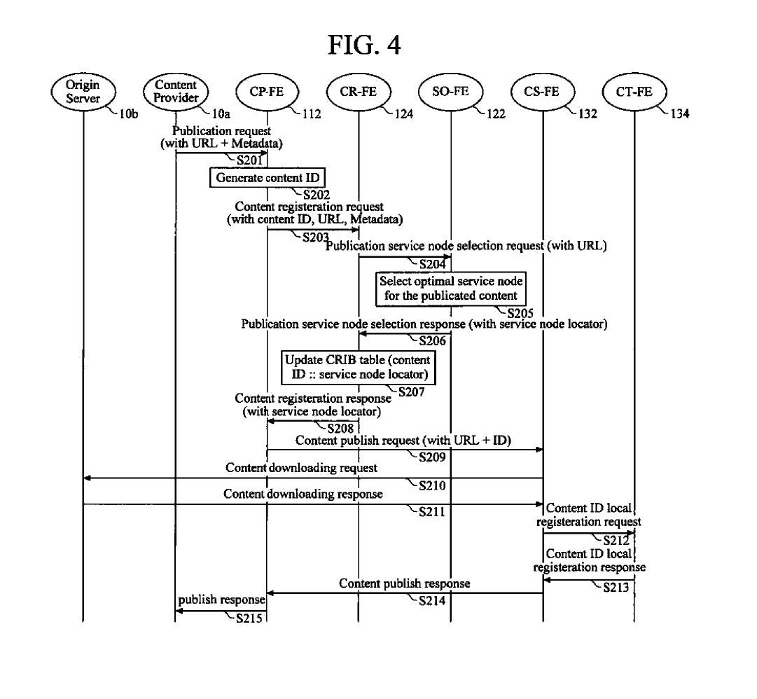

FIGS. 3 and 4 are diagrams illustrating the content publication process using the network node apparatus 100 shown in FIG. 1; FIG. 3 demonstrates an example of a relationship between functions of the network node apparatus 100 during the content publication process, and FIG. 4 demonstrates an example of a message flow chart between functions of the network node apparatus 100 during the content publication process.

Referring to FIG. 3, the content provider 10a sends a publication request for predetermined content to the CSCF 110. The CSCF 110 sends a registration request for the predetermined content to the CDCF, and directs/requests the CDSF 130 to publish the predetermined content. In response to the content publication request, the CDSF 130 downloads the predetermined content from an origin server 10b, and registers content ID of the downloaded content. As a result, the CDSF 130 updates information of content that may be provided as service.

FIG. 4 illustrates an example of a message flow chart according to a procedure of publishing content based on a correlation between the above-described functions of a network node apparatus.

Referring to FIG. 4, the content provider 10a sends a publication request message to the CP-FE 112 in operation S201. The publication request message may include location information of content to be published, including Uniform Resource Locator (URL) and various metadata regarding the content. For example, the metadata may include network identifier information (e.g. IP address) of an origin server regarding the content, an owner of the content and basic information of the content, such as type, size and format thereof.

In addition, the CP-FE 112 generates identifier, such as content ID, of the content to be published, in operation S202. In this embodiment, there is no specific limitation on a method for determining content ID, and, for example, the content ID needs to be the only one on a corresponding network and should not be identical to content ID of different content.

In addition, the CF-FE 112 sends a content registration request message to the CR-FE 124 in operation S203. Content registration indicates setting corresponding content as a service item. The content registration request message may include location information, for example, ULR, of the corresponding content, as well as the content ID generated in operation S202. In addition, all or some of the corresponding content's metadata received in operation S201 may be included in the content registration request message.

The CR-FE 124 transmits a publication service node selection request message to the SO-FE 112 in operation S204. The publication service node selection request message is a message for requesting selection of a service node which is to publish the content requested to be published. The publication service node selection request message may include location information (e.g. URL) and metadata of the content that is requested to be published.

In response to the received publication service node selection request message, the SO-FE 112 selects a publication service node suitable for publishing the corresponding content in operation S205. At this point, the SO-FE 122 may refer to location information (e.g. URL) and/or metadata of the content, which are included in the received publication service node selection request message. According to this embodiment, there is no specific limitation on an algorithm using which the SO-FE 112 selects a publication service node.

The SO-FE 122 transmits a publication service node selection response message to the CR-FE 124 in operation S206. The publication service node selection response message is a response to the publication service node selection request message that is transmitted in operation S204, and may include information on the publication service node that is selected in operation S205. For example, the publication service node selection response message may include location information of the selected publication service node.

In operation S207, the CR-FE 124 updates database, for example, Content name Resolution Information Base (CRIB) table, which is managed using location information of the selected service node, the location information that is included in the received publication service node selection response message. Herein, the CRIB table is a kind of a management table, which is a database that is referred to in order to discover location information of a publication service node using content ID, and the name thereof is merely exemplary. That is, the CRIB table is record of a mapping relationship between content Id and location information of a service node which has published or will publish the corresponding content, and the CRIB table may be, for example, a database that enumerate content ID and location information of the corresponding publication service node.

The CR-FE 124 transmits a content registration response message to the CP-FE 112 in operation S208. The content registration response message is a message transmitted in response to the content registration request message transmitted in operation S203. In a case where the content, requested to be registered in operation S201, is normally registered, the content registration response message may include location information of the publication service node selected in operation S205.

The CP-FE 112 transmits the content publication request message to the CS-FE 132 of the selected publication service node in operation S209. Herein, the selected publication service node may be identified based on location information included in the content registration response message received in operation S208. The content publication request message transmitted in this stage may include content ID and location information of a server that stores the corresponding content, such as URL information of the origin server 10b.

The CS-FE downloads the corresponding content from the origin server 10b in operation S210 and S211. More specifically, the CS-FE 132 transmits a content downloading request message to the origin server 10b with reference to the received location information of the origin server 10b in operation S210. Then, the CSW-FE 132 receives a content downloading response message in response to the content downloading request message in operation S211. The content downloading response message received in operation S211 may include the corresponding content, or the corresponding content may be downloaded through an additional content downloading procedure.

The CS-FE 132 transmits a content ID local registration request message to the CT-FE 132 in operation S212. The content ID local registration request message is a message for requesting registration of the content downloaded in operation S211 to a network. To this end, the content ID registration request message may include the content ID that is downloaded in operation S211.

In response to the content ID registration request message, the CT-FE 134 transmit a content ID registration response message to the CS-FE132 in operation S213. Herein the CT-FE 134 checks whether it is possible to provide a service of content corresponding to the content ID that is received in operation S212 through the content ID local registration request message, and then transmit the content ID registration response message.

In response to the content ID registration response message, the CS-FE 132 transmits a content publication response message to the CP-FE 112. The content publication response message is transmitted in response to the content publication request message that is transmitted in operation S209. Then, the CP-FE 112 transmits a publication response message to the content provider 10oa in operation S215.

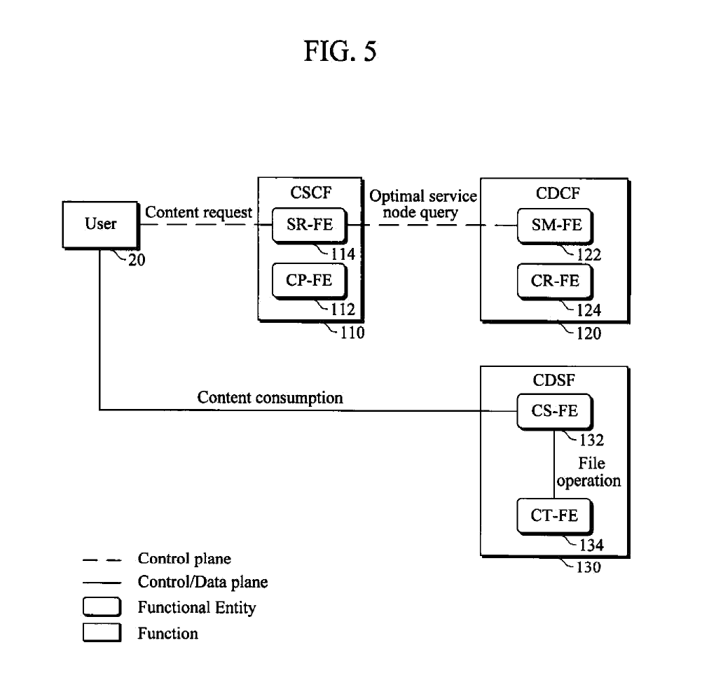

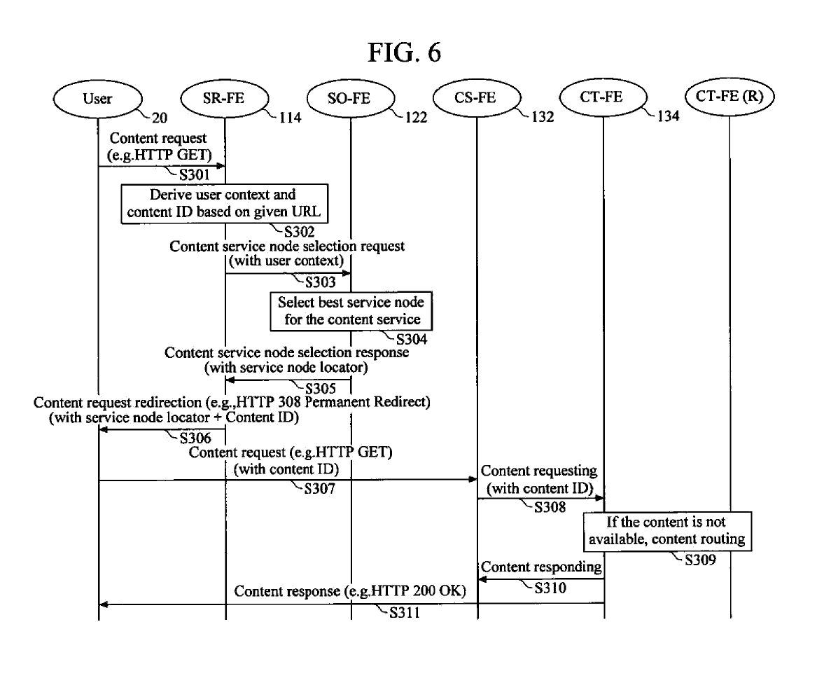

FIGS. 5 and 6 are diagrams illustrating a method for providing content service using the network node apparatus 100 shown in FIG. 1: FIG. 5 demonstrates an example of a correlation relationship between functions of the network node apparatus 100; and FIG. 6 demonstrates an example of a message flow chart between functions of the network node apparatus 100 when content service is provided.

First of all, referring to FIG. 5, the user 20 transmits a content request to the CSCF 110. The CSCF 110 sends an optimal service node query to the CDCF 120 to select a service node suitable for providing content to the user 20. Then, as the user 20 transmits the content request again to the selected content service node that is received from the CSCF 110, the user is provided corresponding content from the content service node, specifically, the CDSF 130, to thereby consume the corresponding content. According to an exemplary embodiment, instead of transmitting the content request again, the user 20 may be provided with content directly from the selected content service node or from the first service node which receives the content request.

FIG. 4 illustrates a message flow chart according to a procedure of providing a content service based on correlation between the above-described functions of the network node apparatus. The procedure of providing a content service may include providing content in response to a content request from a user.

Referring to FIG. 6, the user 20, first of all, transmit a content request message to the SR-FE 114. The content request message may include information used to specify corresponding content (original name of the content). The content request message may include location information, for example, URL, of the corresponding content. If a user enjoys a web service, the content request message may be a Hyper Text Transfer Protocol (HTTP) GET message, but it is merely exemplary.

The SR-FE 114 obtains context information of the user 20 and content ID from the received content request message in operation S302. The context information of the user may include IP address and location information of the user 20. In this stage, the content ID may be obtained using location information, such as URL, of the content, which is included in the content request message.

The SR-FE 114 transmits a content service node selection request message to the SO-FE 122 in operation S303. The content service node selection message is a message for requesting selection of a service node suitable for providing a service of corresponding content to the user 20. The content service node selection message may include context information of a user.

The SO-FE 122 selects a content service node suitable for providing content to the user 20, in operation S304. At this point, the SO-FE 122 may select a service node based on context information of a user, which is included in the received selection request message. For example, the SO-FE 122 may select a content service node close to the user 20 based on location information of the user 20.

The SO-FE 122 transmits a content service node selection response message to the SR-FE 114 in operation S305. The content service node selection response message is transmitted in response to the selection request message that is transmitted in operation S303. Thus, the content service node selection response message may include information that allows access to the content service node selected in operation S304, for example, location information of a content service node.

The SR-FE 114 transmits a content request redirection message to the user 20 in operation S306. The content request redirection message is a message for requesting re-transmission of the content request message to the content service node that is selected in operation S304. For example, in the case where the user 20 enjoys a web service, a HTTP 308 Permanent Redirect message may be used, but it is merely exemplary. Such a content request direction message may include location information of the selected content service node and content ID.

In response to the content request redirection message, the user 20 transmits the content request message to the selected content service node in operation S307. More specifically, the content request message may be transmitted to a CS-FE 132 of the selected content service node. The re-transmitted content request message may include at least information used for identifying corresponding content, that is, content ID. Herein, in the case where a user enjoys a web service, the content request message may be a HTTP GET message, but it is merely exemplary.

Then, the CS-FE 132 of the selected content service node requests the corresponding content from the CT-FE 134 of the selected content service node. The content request in this stage may include the content ID received in operation S307. In the case where the content service node receiving the content request from the user has the requested content, the content service node, more specifically, the CT-FE 134 and the CS-FE 132 immediately proceeds with operation S310 and S311 to deliver the requested content to the user. Alternatively, in the case where the content service receiving the content request from the user does not have the requested content, the CT-FE 134 communicates with a CT-FE(R) of a different service node to perform an operation of discovering the requested content, and obtains the corresponding content in operation S309.

Then, the CT-FE 134 delivers to the CS-FE 132 the requested content which is included in itself or obtained through operation S309. The content delivery in this stage is in response to the content request that is transmitted in operation S308.

The CS-FE 132 transmits a content response message to the user 20 in operation S311. The content response message includes at least the requested content. Herein, in the case where the user enjoys a web service, the content request message may be an HTTP 200 OK message, but it is merely exemplary.

According to the above-described exemplary embodiments, a network node apparatus that realizes Information-Centric Networking (ICN), that is, a data delivering service node (e.g. a router) may significantly reduce an amount of information that needs to be managed for data delivery. Accordingly, even though an amount of content provided as service increases, more burden of infrastructure investigation or management is not placed on a specific network node apparatus, so that scalability may be supported.

According to an exemplary embodiment, content is associated with content identifier (ID) thereof and address information that indicates where the content is stored or cached. Accordingly, it is possible to associate an ICN technology with an existing IP-based service network, such as Content Delivery Network (CDN), and a user.

In addition, according to an exemplary embodiment, a control plane and a data plane are separate from each other, so location information of content is not managed by an object (e.g. a router) located in the data plane, but managed by the control plane concentratedly. Accordingly, even though an amount of content, which is a managed object, increases, the content may be managed efficiently. In addition, as an optimal service node (a content service node and a publication service node) are selected based on context information of a service requester (a user or a content provider) and a service is provided using the optimal service node, a whole traffic volume may be reduced, and thus, the whole network may be efficiently managed.

Those who are skilled in the related art may understand that various and specific modifications may be made without modifying the technical ideas or essential characteristics of the invention. Accordingly, the embodiments disclosed above are exemplary, and should be understandable not to be limited to in all aspects.

What is claimed is:

1. A network node apparatus for Information-Centric Networking (ICN), comprising:
a Content Service Coordination Function (CSCF) configured to, in response to a content request for first content from a user, transmit a query about a first content service node to handle the content request, to receive a response to the query, and to enable the content request to be redirected to the first content service node;
a Content Delivery Control Function (CDCF) configured to, in response to the query from the CSCF which receives the content request, select the first content service node from among one or more content service nodes storing the first content, and to notify the CSCF of the selected first content service node; and
a Content Delivery Service Function (CDSF) configured to, in response to the redirected content request, transmit the first content to the user.

2. The network node apparatus of claim 1, wherein the CSCF is further configured to identify content identifier (ID) of the first content based on address information thereof included in the received content request, and to transmit the query including the content ID of the first content to the CDCF.

3. The network node apparatus of claim 1, wherein:
the CSCF is further configured to derive an Internet Protocol (IP) address of the user and content address information and the content ID of the first content from the received content request, to include the IP address of the user and the content address information and content ID of the first content in a query to be transmitted to the CDCF, and
the CDCF is further configured to select the first content service node as an optimal content service node to handle the content request based on network resource information that includes proximity, network topology and availability.

4. The network node apparatus of claim 1, wherein:
the CDCF is further configured to manage a predetermined database that stores content IDs of contents registered in the network and one or more pieces of content location information corresponding to the respective content IDs, and
the CDSF is further configured to, in response to the redirected content request, transmit the first content to the user using content location information of the first content, the content location information which is identified through communication with the CDCF.

5. The network node apparatus of claim 4, wherein, in the case where the first content is not stored in a storage or a cache of the first content service node, the CDSF is further configured to perform content routing based on the content ID of the first content to receive the first content and to transmit the received first content to the user.

6. The network node apparatus of claim 1, wherein:
the CSCF is further configured to comprise
a Content Service Functional Entity (CSFE) configured to handle the content request and to enable the content request to be redirected,
the CDCF is further configured to comprise
a Service Optimization Functional Entity (SO_FE) configured to select the first content service node from among the one or more content service nodes, and
a Content name Resolution Functional Entity (CR_FE) configured to manage a predetermined database that stores content IDs of contents registered in the network and one or more pieces of content location information corresponding to the respective content IDs, and
the CDSF is further configured to comprise
a Customer Service Functional Entity (CS_FE) configured to transmit the first content to the user, and
a Content Transfer Functional Entity (CT_FE) configured to fetch the first content from a storage by identifying location information of the first content in association with the CR_FE, and to perform routing on the first content along a content routing path.

7. The network node apparatus of claim 1, wherein:
the CSCF is further configured to, in response to a publication request for second content from a content provider, store publication information of the second content, and to send a query about a first publication service node to handle the received publication request to the CDCF so that the publication request for the second content is transmitted to the first publication service node, and
the CDCF is further configured to, in response to the query from the CSCF receiving the publication request, select the first publication service node from one or more publication service nodes, and to notify the selected first publication service node of the CSCF.

8. The network node apparatus of claim 7, wherein the CDSF is further configured to, in response to the publication request for the second content from the CSCF, download the second content from the content provider, and to store the downloaded second content along with the publication information thereof.

9. The network node apparatus of claim 7, wherein:
the CSCF is further configured to comprise
a Content Publication Functional Entity (CP_FE) configured to handle the publication request and generate content ID of the first content,
the CDCF is further configured to comprise
a Service Optimization Functional Entity (SO_FE) configured to select the first publication service node from among the one or more publication service nodes, and
a Content name Resolution Functional Entity (CR_FE) configured to manage a predetermined database that stores content IDs of contents registered in the network and one or more pieces of content location information corresponding to the respective content IDs, and
the CDSF is further configured to comprise
a Customer Service Functional Entity (CSFE) configured to download the second content from the content provider and to store the downloaded second content along with publication information thereof.

10. A content service method using Content Service Coordination Function (CSCF) of a network node apparatus for Information-Centric Networking (ICN), the content service method comprises operations comprising:
(a) receiving a content request for a first content from a user;
(b) sending to a Content Delivery Control Function (CDCF) a query about information on a first content service node for processing the content request;
(c) receiving information on the first content service node that is selected by the CDCF from among one or more service nodes storing the first content; and
(d) enabling the content request to be redirected to the first content service node so that a Content Delivery Service Function (CDSF) on the first content service node transmits the first content to the user.

11. The content service method of claim 10, wherein:
the operation (b) further comprises identifying content identifier (ID) of the first content based on content address information thereof included in the received content request, including the identified content ID of the first content in the query, and transmitting the query to the CDCF.

12. The content service method of claim 11, wherein:
the operation (d) comprises transmitting a redirecting request to redirect the content request for the first content to the first content service node, and
in response to the redirecting request, transmitting the content request for the first content from the user to the CDSF on the first content service node using the content ID of the first content.

13. The content service method of claim 12, wherein, after the operation (d),
the CDSF is further configured to, in response to the content request, transmit to the CDCF the content request for the first content using the content ID of the first content, and
the CDCF is further configured to transmit the first content to the CDSF by fetching the first content from a storage or a cache or performing routing the first content along a content routing path.

14. A content publication method using a Content Service Coordination Function (CSCF) of a network node apparatus for Information-Centric Networking (ICN), the content publication method comprises operations comprising:
(a) receiving a publication request for first content from a content provider;
(b) generating content identifier (ID) of the first content;
(c) transmitting to a Content Delivery Control Function (CDCF) a query about information on a first publication service node to handle the publication request;
(d) receiving information on the first publication service node that is selected by the CDCF from among one or more publication service nodes; and
(e) transmitting the publication request for the first content to the CDCF so that the CDSF downloads the first content from the content provider.

15. The content publication method of claim 14, wherein:
the operation (c) further comprises transmitting to the CDCF a content registration request message that includes the content ID of the first content and address information of the content provider, and
the operation (d) further comprises receiving from the CDCF a content registration response message that includes address information of the first publication service node.

16. The content publication method of claim 15, wherein:
the operation (d) further comprises transmitting from a Content name Resolution Functional Entity (CR_RE) of the CDCF to a Service Optimization Functional Entity (SO_FE) of the CDCF a publication service node request, and transmitting from the SO_FE to the CR-FE a publication service node selection response that includes address information of the first publication service node selected from among the one or more publication service nodes.

17. The content publication method of claim 14, wherein:
the operation (f) further comprises, in response to the content publication request, receiving a content publication response from the CDSF that registers the first content.
